(19) United States
(12) Patent Application Publication
(10) Pub. No.: US 2009/0164756 A1
(43) Pub. Date: Jun. 25, 2009

(54) Geological Response Data Imaging With Stream Processors

(76) Inventors: Tor Dokken, Oslo (NO); Martin Ofstad Henriksen, Oslo (NO); Jorg Aarnes, Asker (NO); Knut-Andreas Lie, Oslo (NO)

Correspondence Address: WENDEROTH, LIND & PONACK, L.L.P., 1030 15th Street, N.W.,, Suite 400 East, Washington, DC, 20005-1503, US

(21) Appl. No.: 12/083,680

(22) PCT Filed: Oct. 18, 2006
(86) PCT No.: PCT/NO2006/000364

§ 371 Date: Nov. 4, 2008

Related U.S. Application Data
(60) Provisional application No. 60/727,502, filed on Oct. 18, 2005.

(51) Int. Cl. G06F 15/76; G06F 9/06

(52) U.S. Cl. 712/36; 712/E09.003

(57) ABSTRACT

The invention describes a method to convert geological response data to graphical raw data by using at least one stream processor for this purpose. The geological response data is pre-processed by a CPU and the preprocessed geological response data is fed into one or more stream processors. The stream processor then does the calculation intensive work on the preprocessed geological response data and returns the processing results back to the CPU which does some post-processing on the results coming from the stream processor Stream processors comprise single or multiple programmable GPUs, clusters/networks of nodes with one or several GPU's; cell processors (or processors derived from it) or a cluster of cell processor nodes, game computers (in the spirit of Sony's PlayStation, Nintendo's GameCube, etc.) or clusters of game computers.

### TECHNICAL FIELD

The present invention relates to the field of geological imaging. Specifically it relates to the application of stream processor based computational devices to convert geological data obtained by seismic acquisition to images.

### BACKGROUND

### Geological Imaging

Geological data are gathered by methods such as seismic reflection, ultrasound, magnetic resonance, etc., and processed to create an image of underground structures. The computer processing of the data is complex and contains a succession of filters (deconvolution, wavelets methods, statistic methods), migration (pre-stack or post-stack with Kirchhoff migration, wave equation methods . . . ) and imaging methods (see FIG. 1). The data sets are large, and the processing is challenging; the methods producing the best quality images with few artefacts, tend to be the most demanding with regard to computer time and memory. Often the application is implemented on a parallel computer or network of computers.

Looking away from input and output operations, transformations to specific data formats and other tasks of pre- or post-processing type, one can isolate a group of instructions that perform the main calculation—name this group of instructions the core calculation. It usually involves discreet Fourier transforms, convolutions or some other type of filtering, or it may involve numerical integration or the application of a differential operator. Unless the application is bound by I/O-operations, improving the speed of the core calculation can benefit the overall time usage.

### Stream Processor

A so-called stream processor applies a defined set of instructions to each element of its input stream (the input data), producing an output stream. The defined set of instructions, call it the kernel, stays fixed for the elements of the stream, i.e., the kernel can be changed on the stream level. A stream processor might also allow for multiple kernels. The kernel's data usage is local and independent of the processing of other elements in the stream, and this allows the stream processor to execute its kernel significantly faster than an analogue set of instructions would execute on a central processing unit (CPU). A prime example of a stream processor is the (programmable) graphics processor unit (GPU). Another example is the cell processor, which can be seen as a tight integration of several stream processors (called Synergistic Processing Elements in the context of the cell processor). Stream processing hardware is well suited to the execution of the abovementioned kernel of geological data processing.

### SUMMARY

The present invention is a method and a corresponding system to convert geological response data to graphical raw data which involves a number of steps.

The geological response data is preprocessed by at least one CPU and the resulting preprocessed geological response data is fed into at least one stream processor. The preprocessed geological response data is further processed inside at least one stream processor and the processing results from this step are received at the at least one CPU from said at least one stream processor. Further post-processing of the processing results are performed by said at least one CPU. The at least one stream processor performs on said geological response data at least one of deconvolution, corrections and filtering comprising noise filtering, multiple suppression, NMO correction, spherical divergence correction, sorting, time-to-depth conversion comprising velocity analysis, post-stack image processing, pre-stack image processing and migration. Said sorting can be coupled to said time-to-depth conversion. The method/system can involve manual checking of the computational results after each stage and re-iterating with a reduced latency on critical tasks. The noise filtering can be based on local statistical methods and ultra fast calculations, and the stream processor (s) can be used to compare n (n>1) geological images derived from n sets of geological raw data taken at different times ti (2≦i≦n). Said at least one stream processor is one of at least one programmable Graphical Processing Unit (GPU), a cluster of nodes with CPU's with at least one core and at least one GPU, a cell processor, a processor derived from a cell processor, a cluster of cell processor nodes, a massively parallel computer with stream processors attached to at least one of its CPU's, a game computer and a cluster of game computers.

In detail the invention is characterized by the attached patent claims.

### BRIEF DESCRIPTION OF THE DRAWINGS

The invention will be described in the following section with reference to the. attached drawings, where

FIG. 1 shows an optimized workflow,

FIG. 2 shows the stream processor operations realized during first stage,

FIG. 3 is a schematic example of the 2 possible processing flows: the traditional post-stack calculations and the now possible pre-stack workflow.

FIG. 4 shows stream processor operations on two sets of data (“4D processing”).

### DETAILED DESCRIPTION OF PREFERRED EMBODIMENTS

In the following, preferred embodiments of the invention are described in detail with reference to the attached drawings.

The idea is to use one or more stream processors (also called “Parallel computing nodes” in the drawings 205, 302, 405) in conjunction with one or more CPUs, and to organize the application such that the CPUs handle the data input and all preparations of the input streams to the kernels, and all post-processing of the kernel's output stream and output to files or similar tasks. The stream processors are invoked by the CPUs, and execute the core calculation. Examples of computer architectures that can be used to implement such an application include:
a single processor desktop computer with a programmable GPU;
a multi-kernel (multiprocessor) desktop computer with multiple GPU's;
a cluster/network of nodes with single or multi-processor CPU's and one or several GPU's;
a desktop computer with a cell processor (or a processor derived from it) or a cluster of cell processor nodes;
a massively parallel computer with stream processors attached to some or all of its CPU's;
a game computer (in the spirit of Sony's PlayStation, Nintendo's GameCube, etc.) or a cluster of game computers.

Using both CPUs and stream processors, software applications for the processing of geological response data can be implemented with the stream processors as coprocessors doing the core calculation. The enhanced computational speed within the stream paradigm is thus made available to this very demanding type of applications.

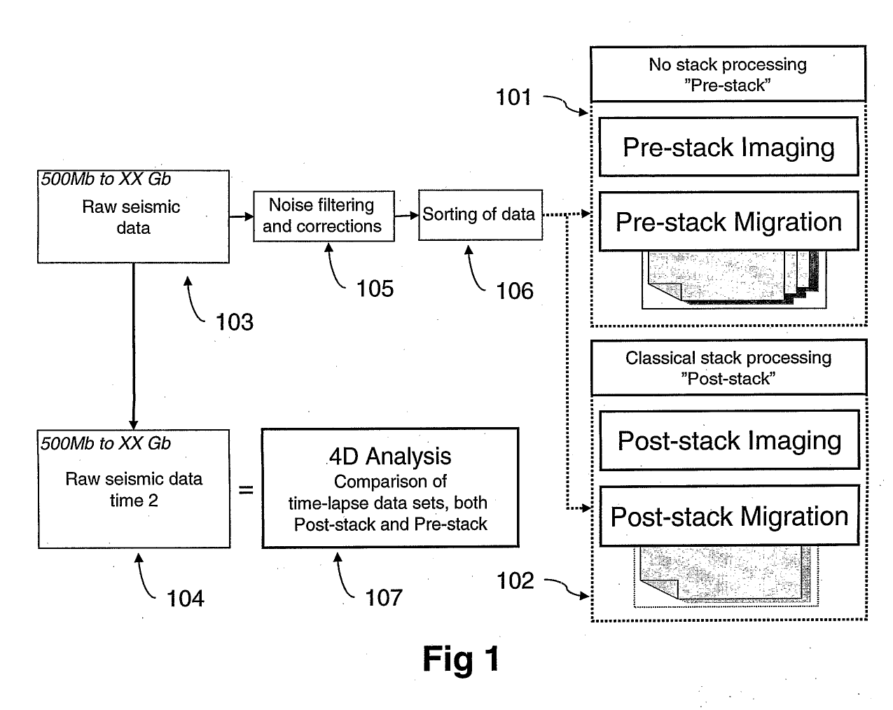

FIG. 1 shows a quick overview of an optimized automatic workflow processed by a stream processor indicated by double arrows. The raw seismic data 103 (usually of huge volume; 500 MByte and up to several GByte) is used as input of geological image. Stream processors can handle huge amounts of data resuiting in no need for compression of data.

The stage “Noise filtering and correction” 105 corresponds to a large amount of mathematical calculations, usually costly and without any possible iteration. By using a stream processor the user can control, modify and re-iterate all these operations.

“Sorting of data” 106 is a necessary step; it can be immediately coupled to the depth conversion phase (from milliseconds, acquisition time to meters, geological unit) thanks to the advanced calculations facilities of the stream processor.

Then there are two choices to manipulate the seismic image: either by a classical post-stack imaging process 101 where the stack allows compression of the amount of data or directly in a pre-stack imaging process 102. This second alternative is recognized as much more accurate for low quality data (bad signal/noise ratio, bad illuminations, complex geology) but has to handle a higher volume of data (no stacking of the data) and therefore is not always possible with current technologies.

After the migration and time-to-depth conversion, one has obtained a geological image of the data. Additionally a new step is now possible. Comparing the obtained image with the image obtained from the same place but acquired at a different time 104 (time-lapse processing). Indeed the stream processor allows handling of multiple datasets, calculations, comparison and feature recognition process 107.

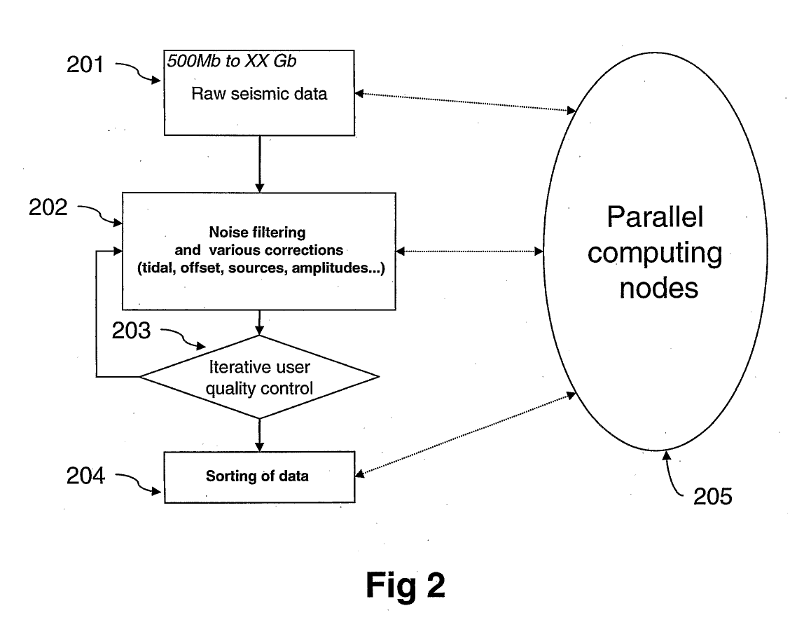

FIG. 2 shows the operations 202 performed by the stream processor 205 on the data 201 during the first stage of the proposed automatic processing: improved I/O, improved storage (reducing the need for data volume decimation), fast Fourier transform; fast corrections and filters. The noise filtering can be based on both global and local statistical methods and ultra fast calculations allowing a better emphasis of each geological structure.

The user is checking the result after each stage 203 and can re-iterate the operations with a reduced latency on critical tasks. Using advantages of stream processors for fast sorting of data 204 (traditionally into CommonDepthPoint gathers) this step is no longer a hindrance in the speed of the workflow.

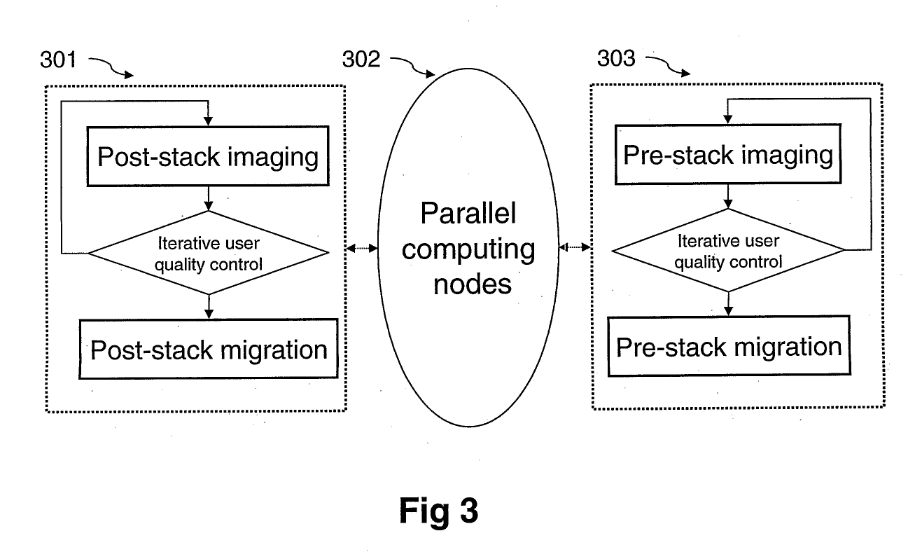

FIG. 3 shows the stream processor 302 operations realizing a proper image of the geological data (multiple eliminations, time-to-depth conversion, and migration). In the Post-stack migration alternative 301, phase shift migration, FK-migrations, FD migration (finite difference) both in time and depth and Kirchhoff (time and depth) can be performed, while the Pre-stack alternative 303 (Pre-stack data carries much more valuable information but is too heavy to handle for actual processors.) comprises Kirchhoff compensation, depth migration (PSDM), Monte Carlo wave field statistical method and time migration (right side of FIG. 3). The migration methods listed are well-known but very often costly.

A user-controlled process allowing iterations is suggested here for both alternatives. In addition instantaneous attribute calculations can be performed.

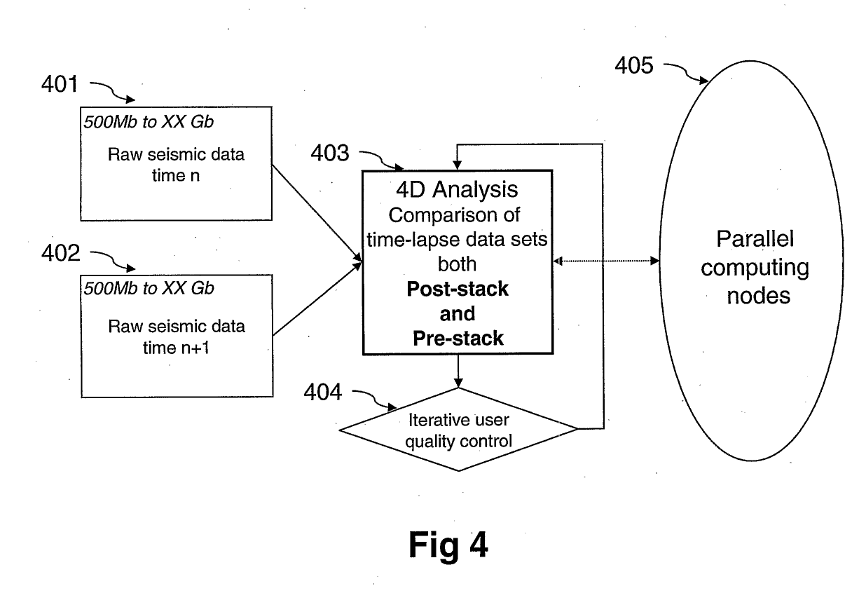

FIG. 4 relates to strategic decisions concerning reservoir monitoring and shows the stream processor 405 operations on two sets of data 401, 402 authorizing the so-called “4D processing” 403. The stream processor allows a full comparison of the multi 3D sets of data, emphasizing any changes in time (fluid migration, pressure variation) and any attribute analysis necessary for a better understanding of the geological image (amplitude versus offset, signal/noise-ratio, impedance, NRMS). The process further allows the automatic subtraction of non repeatable noise and features recognition. Again a user-controlled process allows iterations for quality control 404.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1-9. (canceled)

10. Method to convert geological response data (103) to graphical raw data comprising the following steps:
preprocessing geological response data by at least one CPU (central data processing unit),
feeding said preprocessed geological response data into at least one stream processor (205, 302, 405),
processing said preprocessed geological response data inside said at least one stream processor,
characterized by receiving processing results at said at least one CPU from said at least one stream processor, and post-processing said processing results by said at least one CPU.

11. Method according to claim 10, characterized by using said at least one stream processor to perform on said geological response data at least one of
deconvolution;
corrections and filtering comprising noise filtering, multiple suppression, NMO correction, spherical divergence correction;
sorting the data without decimation;
time-to-depth conversion comprising velocity analysis;
post-stack image processing (102, 301);
pre-stack image processing (101, 303); and
migration.

12. Method according to claim 11, characterized by having said sorting the data without decimation coupled to said time-to-depth conversion.

13. Method according to claim 11, characterized by manually checking computational results after each stage and re-iterating with a reduced latency on critical tasks.

14. Method according to claim 12, characterized by the noise filtering (105) being based on local statistical methods and ultra fast calculations.

15. Method according to claim 10, characterized by using said stream processor (405) to compare (403) n (n>1) geological images derived from n sets of geological raw data (401, 402) taken at different times tᵢ (2≦i≧n).

16. Method according to claim 10, characterized in that said at least one stream processor is one of
at least one programmable Graphical Processing Unit (GPU);
a cluster of nodes with CPU's with at least one core and at least one GPU;
a cell processor;
a processor derived from a cell processor;
a cluster of cell processor nodes;
a massively parallel computer with stream processors attached to at least one of its CPU's;
a game computer; and
a cluster of game computers.

17. System to convert geological response data to graphical raw data characterized by
at least one CPU (central data processing unit) arranged to:
(a) preprocess geological response data (103),
(b) feed said preprocessed geological response data into at least one stream processor,
(c) receive processing results from said at least one stream processor,
(d) post-process said processing results,
at least one stream processor arranged to process said preprocessed geological response data.

18. System according to claim 17, characterized by the at least one stream processor being one of
at least one programmable Graphical Processing Unit (GPU);
a cluster of nodes with CPU's with at least one core and at least one GPU;
a cell processor;
a processor derived from a cell processor;
a cluster of cell processor nodes;
a massively parallel computer with stream processors attached to at least one of its CPU's;
a game computer; and
a cluster of game computers.

19. Method according to claim 11, characterized in that said at least one stream processor is one of
at least one programmable Graphical Processing Unit (GPU);
a cluster of nodes with CPU's with at least one core and at least one GPU;
a cell processor;
a processor derived from a cell processor;
a cluster of cell processor nodes;
a massively parallel computer with stream processors attached to at least one of its CPU's;
a game computer; and
a cluster of game computers.

20. Method according to claim 15, characterized in that said at least one stream processor is one of
at least one programmable Graphical Processing Unit (GPU);
a cluster of nodes with CPU's with at least one core and at least one GPU;
a cell processor;
a processor derived from a cell processor;
a cluster of cell processor nodes;
a massively parallel computer with stream processors attached to at least one of its CPU's;
a game computer; and
a cluster of game computers.
